(19) United States
(12) Patent Application Publication
(10) Pub. No.: US 2018/0151956 A1
(43) Pub. Date: May 31, 2018

(54) LINEAR ANTENNA AND ELECTRONIC DEVICE

(71) Applicant: FUJITSU LIMITED, Kawasaki-shi (JP)

(72) Inventor: Yasumitsu BAN, Yokohama (JP)

(73) Assignee: FUJITSU LIMITED, Kawasaki-shi (JP)

(21) Appl. No.: 15/817,439

(22) Filed: Nov. 20, 2017

(30) Foreign Application Priority Data
Nov. 25, 2016 (JP) 2016-229409

(51) Int. Cl. H01Q 9/04; H01Q 1/48

(52) U.S. Cl. CPC H01Q 9/0414; H01Q 1/48; H01Q 9/045

(57) ABSTRACT

A linear antenna includes a first conductor which is formed as a plate and is grounded; and a second conductor which is connected at one end to the first conductor, includes an electrical length obtained by adding ¼ of a designed wavelength to an integer multiple of a half of the designed wavelength, and includes a first section from a folding point to an another end of which the second conductor is an open end along a surface parallel to a surface on which the first conductor is formed, wherein the second conductor is fed at a feed point in the first section, and at least a part of the first section including the feed point is formed to overlap with the first conductor when the first section is projected along a normal direction of the surface on which the first conductor is formed.

### CROSS-REFERENCE TO RELATED APPLICATION

This application is based upon and claims the benefit of priority of the prior Japanese Patent Application No. 2016-229409, filed on Nov. 25, 2016, and the entire contents of which are incorporated herein by reference.

### FIELD

The embodiments discussed herein are related to a linear antenna and an electronic device that includes a linear antenna.

### BACKGROUND

Conventionally, a linear antenna such as an inverse L-shape antenna has been used, in which the radiating electrode grounded at one end is folded in the middle so as to be substantially parallel to a grounded conductor (e.g., please refer to Japanese Laid-open Patent Publications Nos. 2002-237711, 2002-368850, and 2006-197138). Such a linear antenna can have a low profile, and as a result can be used in small radio terminals, for example.

### SUMMARY

Various installation environments can be considered depending on usages of the apparatus in which the linear antenna is incorporated. For example, the apparatus can be used by being placed on another conductor, or in an environment with no conductor nearby.

When the installation environment varies in this way, the radiation property of the linear antenna also changes. However, when the radiation property of the linear antenna varies too much, a desirable antenna gain is not achieved in some cases depending on the installation environment.

According to one embodiment, a linear antenna is provided. The linear antenna includes: a first conductor which is formed as a plate, is conductive and is grounded; and a second conductor which is conductive, is connected at one end of the second conductor to the first conductor, includes an electrical length obtained by adding ¼ of a designed wavelength to an integer multiple of a half of the designed wavelength and includes a first section from a folding point between the one end and an another end of which the second conductor is an open end to the another end along a surface parallel to a surface on which the first conductor is formed, wherein the second conductor is fed at a feed point in the first section, and at least a part of the first section including the feed point is formed to overlap with the first conductor when the first section is projected along a normal direction of the surface on which the first conductor is formed.

According to another embodiment, an electronic device is provided. The electronic device includes: a substrate; a linear antenna; and a signal processing circuit which is mounted on one surface of the substrate, and is configured to radiate or receive a radio wave via the linear antenna, wherein the linear antenna includes: a first conductor which is mounted on a surface opposite to the one surface of the substrate, is conductive and is grounded; and a second conductor which is conductive, is connected at one end of the second conductor to the first conductor, includes an electrical length obtained by adding ¼ of a designed wavelength to an integer multiple of a half of the designed wavelength, and includes a first section from a folding point between the one end and an another end of which the second conductor is an open end to the another end along the one surface of the substrate, wherein the second conductor is connected to the signal processing circuit at a feed point in the first section, and at least a part of the first section including the feed point is formed to overlap with the first conductor when the first section is projected along a normal direction of the surface on which the first conductor is formed.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a perspective view of a linear antenna according to a first embodiment.

FIG. 2A is a perspective view of the linear antenna according to the first embodiment, which indicates a size of each part used for electromagnetic field simulation of frequency characteristics of the linear antenna.

FIG. 2B illustrates an equivalent circuit when the linear antenna is connected to a matching circuit.

FIG. 3 is a diagram illustrating frequency characteristics of an antenna gain in the front direction, when an inverse L-shape antenna according to a comparative example and the linear antenna according to the first embodiment are placed in the air and when the inverse L-shape antenna and the linear antenna are placed on an object made of metal.

FIG. 4 is a perspective view of a linear antenna according to a second embodiment.

FIG. 5 is a diagram illustrating frequency characteristics of an antenna gain in the front direction, when the linear antenna according to the second embodiment is placed in the air and when the linear antenna according to the second embodiment is placed on an object made of metal.

FIG. 6 is a perspective view of a linear antenna according to a modification example of the second embodiment.

FIG. 7 is a diagram illustrating frequency characteristics of an antenna gain in the front direction, when the linear antenna according to the modification example illustrated in FIG. 6 is placed in the air and when the linear antenna according to the modification example illustrated in FIG. 6 is placed on an object made of metal.

FIG. 8 is a perspective view of a linear antenna according to another modification example of the second embodiment.

FIG. 9 is a diagram illustrating frequency characteristics of an antenna gain in the front direction, when the linear antenna according to the modification example illustrated in FIG. 8 is placed in the air and when the linear antenna according to the modification example illustrated in FIG. 8 is placed on an object made of metal.

FIG. 10 is a perspective view of a linear antenna according to still another modification example of the second embodiment.

FIG. 11 is a diagram illustrating frequency characteristics of an antenna gain in the front direction, when the linear antenna according to the modification example illustrated in FIG. 10 is placed in the air and when the linear antenna according to the modification example illustrated in FIG. 10 is placed on an object made of metal.

FIG. 12A is a perspective view of a modification example of the linear antenna whose grounded conductor includes a cut-off portion.

FIG. 12B is a perspective view of a modification example of the linear antenna whose grounded conductor includes a cut-off portion.

FIG. 12C is a perspective view of a modification example of the linear antenna whose grounded conductor includes a cut-off portion.

FIG. 12D is a perspective view of a modification example of the linear antenna whose grounded conductor includes a cut-off portion.

FIG. 13 is a diagram illustrating a size of each part of the grounded conductor, when the antenna gain for the linear antenna according to the modification example illustrated in FIG. 12D placed in the air substantially matches with the antenna gain for the linear antenna placed on an object made of metal, at a certain frequency band.

FIG. 14 is a diagram illustrating frequency characteristics of an antenna gain in the front direction, when the linear antennas according to the modification examples illustrated in FIG. 12D and FIG. 13 are placed in the air and when the linear antennas are placed on an object made of metal.

FIG. 15A is a perspective view of a modification example of the linear antenna whose radiation conductor is formed so that the portion other than the parallel track portion of the radiation conductor is positioned inner than the outer edge of the grounded conductor.

FIG. 15B is a perspective view of a modification example of the linear antenna whose radiation conductor is formed so that the portion other than the parallel track portion of the radiation conductor is positioned inner than the outer edge of the grounded conductor.

FIG. 15C is a perspective view of a modification example of the linear antenna whose radiation conductor is formed so that the portion other than the parallel track portion of the radiation conductor is positioned inner than the outer edge of the grounded conductor.

FIG. 16 is a schematic perspective view of an electronic device which includes the linear antenna according to any of the embodiments or their modification examples described above, viewed from the front surface side of the substrate.

FIG. 17 is a block diagram of circuitry included in the electronic device illustrated in FIG. 16.

### DESCRIPTION OF EMBODIMENTS

The following describes a linear antenna with reference to the drawings. This linear antenna includes a grounded conductor formed as a plane plate, and a linear radiation conductor connected to the grounded conductor at one end and being open at the other end. The radiation conductor is formed so that the section from the folding point in the vicinity of the one end connected to the grounded conductor to the open end is substantially parallel to the surface on which the grounded conductor is provided, and that at least a part of the radiation conductor overlaps with the grounded conductor when the radiation conductor is projected over the grounded conductor in the normal direction of the grounded conductor. Furthermore, the radiation conductor is fed in the middle of the above-noted section, and has an electrical length of (¼+N/2)λ with respect to the designed wavelength λ (N is an integer of not lower than 1). By doing so, this linear antenna suppresses the variation in antenna gain due to the difference in the installation environment. In the following description, “the radiation conductor overlaps with the grounded conductor when the radiation conductor is projected in the normal direction of the grounded conductor” is simply expressed as “the radiation conductor overlaps with the grounded conductor” for the convenience of explanation.

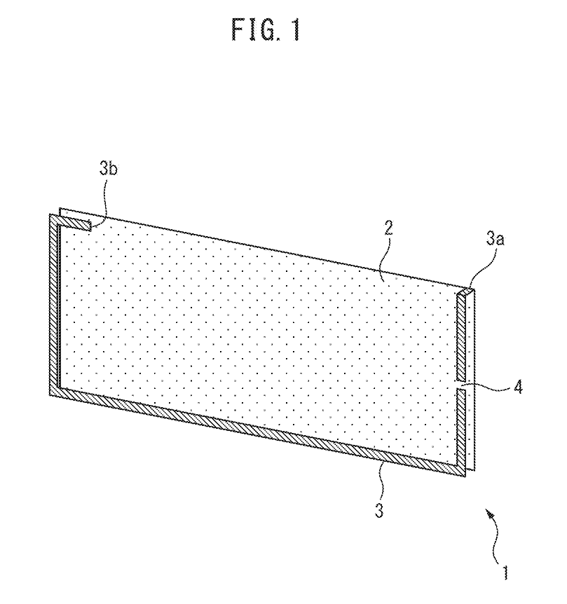

FIG. 1 is a perspective view of a linear antenna according to a first embodiment. The linear antenna 1 according to the first embodiment includes a grounded conductor 2 and a radiation conductor 3.

The grounded conductor 2 is an example of a first conductor being grounded, and is formed as a plane plate by a conductor such as copper or gold, for example. In addition, in the example illustrated in FIG. 1, the grounded conductor 2 is formed to have a rectangular shape.

The radiation conductor 3 is an example of a second conductor, and is formed to be linear by a conductor such as copper or gold, for example. In addition, the radiation conductor 3 has an electrical length being substantially (¼+N/2)λ with respect to the designed wavelength λ corresponding to the frequency of the radio wave in which the linear antenna 1 is used, wherein N is an integer not lower than 1. Accordingly, the radiation conductor 3 resonates with the radio wave having a designed wavelength λ, and therefore can receive or radiate the radio wave having the designed wavelength λ. Furthermore, by setting the length of the radiation conductor 3 to be substantially (¼+N/2)λ instead of substantially λ/4, the variation in antenna gain due to the difference in installation environment will be suppressed.

The radiation conductor 3 is connected to the grounded conductor 2 at one end 3a thereof and is open at the other end 3b thereof. Note that in the following description, the one end 3a of the radiation conductor 3 connected to the grounded conductor 2 is referred to as a fixed end. In the present embodiment, the fixed end 3a is provided at one corner of the grounded conductor 2, and the radiation conductor 3 is folded at a folding point located away from the fixed end 3a by a certain distance to be substantially parallel to the grounded conductor 2, and is extended along the outer edge of the grounded conductor 2. In addition, the radiation conductor 3 is positioned to overlap with the grounded conductor 2. The radiation conductor 3 is fed at the feed point 4 provided between the folding point and the open end 3b. By doing so, when the linear antenna 1 is positioned on another conductor, the influence of the other conductor on the radiation conductor 3 will be alleviated. The feed point 4 is preferably set so that the distance from the open end 3b to the feed point 4 is not nλ/2, wherein n is an integer not lower than 1. By doing so, the open end 3b does not function as a node of a standing wave for the radio wave having the designed wavelength, and thereby make it harder for the radiation conductor 3 to radiate the radio wave.

Note that the grounded conductor 2 and the radiation conductor 3 may be integrally formed of one conductor. The grounded conductor 2 may also be formed on one surface of a substrate (not illustrated in the drawings) formed of a dielectric, and the section of the radiation conductor 3 from the folding point to the open end 3b may be mounted on the other surface of the substrate.

The following explains the radiation property of the linear antenna 1, which is obtained by the electromagnetic field simulation. In the following explanation, the frequency characteristics of the antenna gain are obtained under the assumption that the linear antenna according to the embodiments and the modification examples is used in 2.4 GHz to 2.48 GHz which is used in BLE (Bluetooth Low Energy) (registered trademark) in the electromagnetic field simulation for the linear antenna.

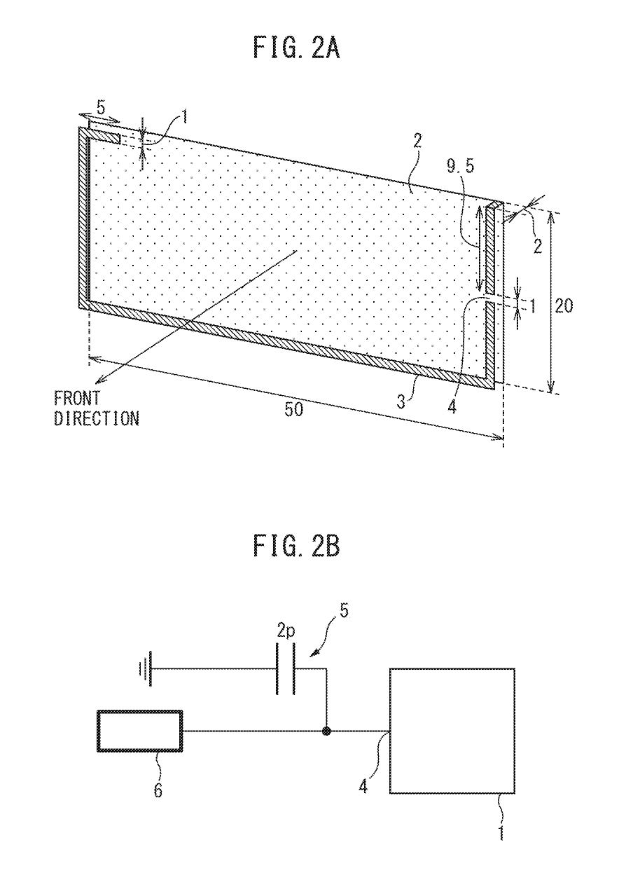

FIG. 2A is a perspective view of a linear antenna 1 according to the first embodiment, which indicates a size of each part used for electromagnetic field simulation of frequency characteristics of the linear antenna 1. In this simulation, the conductivity of the grounded conductor 2 and the radiation conductor 3 is 1.0×10⁵ (S/m). The grounded conductor 2 has a size of 50 mm in the lengthwise direction, and a size of 20 mm in the widthwise direction. The line width of the radiation conductor 3 is 1 mm. The interval between the grounded conductor 2 and the radiation conductor 3, other than at the fixed end, is 2 mm. The distance from the fixed end to the feed point 4 is 11.5 mm (i.e. the distance from the folding point to the feed point 4 is 9.5 mm). At the feed point 4, there is an interval of 1 mm between the portion from the fixed end to the feed point 4 and the portion from the open end to the feed point 4 in the radiation conductor 3. The length of the entire radiation conductor 3 is 94 mm which is substantially ¾ of about 125 mm which is the designed wavelength which corresponds to the frequency of 2.4 GHz. In the following explanation, the direction from the grounded conductor 2 to the radiation conductor 3 along the normal line of the grounded conductor 2 will be referred to as “the front direction.”

Further, as the installation environment of the linear antenna 1, a case when the linear antenna 1 is placed in the air and a case when the linear antenna 1 is placed on a plane surface formed of another conductor (hereinafter referred to as “on an object made of metal” for convenience in the following explanation) are assumed. When the linear antenna 1 is placed on a metal, an interval between the surface (hereinafter referred to as “back surface”) of the grounded conductor 2 opposite to a surface where the radiation conductor 3 is provided and the plane surface formed of the other conductor is 0.1 mm.

FIG. 2B illustrates an equivalent circuit when the linear antenna is connected to a matching circuit. A matching circuit 5 may be connected between a signal processing circuit 6 and the feed point 4 in the linear antenna 1, so that the impedance of the linear antenna 1 matches with a certain impedance under a certain installation environment. As described later, when the linear antenna 1 having a size of each part as illustrated in FIG. 2A is placed on an object made of metal, the matching circuit 5, for example, includes a capacitor which is connected to the linear antenna 1 in parallel and has 2 pF.

The antenna gain in the front direction for an inverse L-shape antenna is also obtained as a comparative example. The inverse L-shape antenna according to the comparative example includes: a grounded conductor 2 having the sizes as illustrated in FIG. 2A; and a radiation conductor having one end thereof connected in the middle of the short side on the left of the grounded conductor 2 and extending along the outer edge of the grounded conductor 2. The length of the radiation conductor of the inverse L-shape antenna according to the comparative example is 26.5 mm (i.e., the length is substantially ¼λ) and the line width thereof is 1 mm.

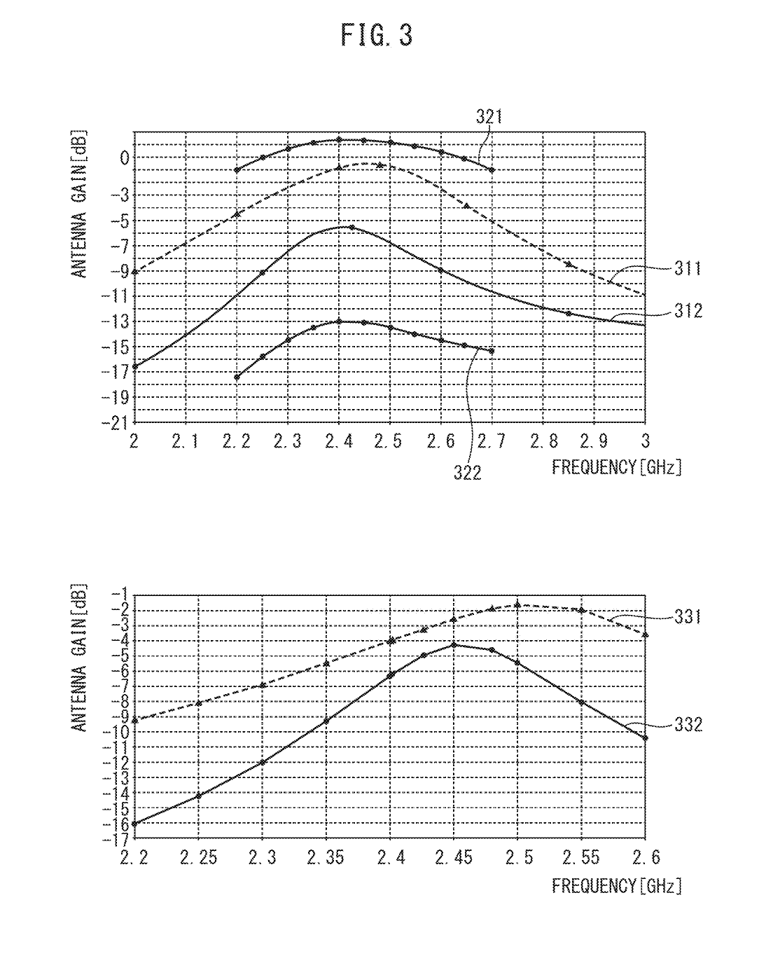

FIG. 3 is a diagram illustrating frequency characteristics of an antenna gain in the front direction, when an inverse L-shape antenna according to a comparative example and the linear antenna 1 according to the first embodiment are placed in the air and when the inverse L-shape antenna and the linear antenna 1 are placed on an object made of metal. In FIG. 3, the horizontal axis represents a frequency, and the vertical axis represents an antenna gain in the front direction in the impedance matched condition.

The graph 311 represents frequency characteristics of the antenna gain when the linear antenna 1 is placed in the air. The graph 312 represents frequency characteristics of the antenna gain when the linear antenna 1 is placed on an object made of metal. The graph 321 represents frequency characteristics of the antenna gain when the inverse L-shape antenna according to the comparative example is placed in the air. The graph 322 represents frequency characteristics of the antenna gain when the inverse L-shape antenna according to the comparative example is placed on an object made of metal.

For the linear antenna 1, the minimum difference between the antenna gains respectively resulting when the linear antenna 1 is placed in the air and when the linear antenna 1 is placed on an object made of metal is about 6 dB. On the other hand, for the inverse L-shape antenna according to the comparative example, the minimum difference in the antenna gains respectively resulting when the inverse L-shape antenna is placed in the air and the inverse L-shape antenna is placed on an object made of metal is about 14.5 dB. From this, it is understood that the linear antenna 1 is able to suppress the variation in antenna gain due to the difference in installation environment.

The graph 331 represents frequency characteristics of the antenna gain of the linear antenna 1 which is placed in the air when the matching circuit 5 matches the impedance of the linear antenna 1 to 50Ω with reference to a case in which the linear antenna 1 is placed on an object made of metal. The graph 332 represents frequency characteristics of the antenna gain of the linear antenna 1 which is placed on an object made of metal when the matching circuit 5 matches the impedance of the linear antenna 1 to 50Ω with reference to a case in which the linear antenna 1 is placed on an object made of metal.

By matching the impedance of the linear antenna 1 with reference to a case in which the linear antenna 1 is placed on an object made of metal, the antenna gain of the linear antenna 1 which is placed on an object made of metal improves. Therefore, the minimum difference between the antenna gains respectively resulting when the linear antenna 1 is placed in the air and when it is placed on an object made of metal will be decreased down to about 2.5 dB.

As described so far, in this linear antenna, the electrical length of the radiation conductor is about (¼+N/2)λ, the radiation conductor and the grounded conductor are placed to overlap with each other, and the radiation conductor is fed at between its folding point and the open end. According to this, even when there is another conductor in proximity to this linear antenna, this linear antenna can alleviate the influence of the other conductor on the radiation conductor, and can suppress the variation in antenna gain between when the linear antenna is placed in the air and when the linear antenna is placed on an object made of metal. Furthermore, by matching the impedance of the linear antenna to a certain impedance with reference to a case in which the linear antenna is placed on an object made of metal, this linear antenna can suppress the variation in antenna gain between when the linear antenna is placed in the air and on an object made of metal. Still further, this linear antenna does not always need to use, as a matching circuit, a circuitry element such as a capacitor having a very small capacity and having a tolerance which is not very accurate. Therefore, it becomes easy to match the impedance of this linear antenna with a certain impedance.

The following explains a linear antenna according to a second embodiment.

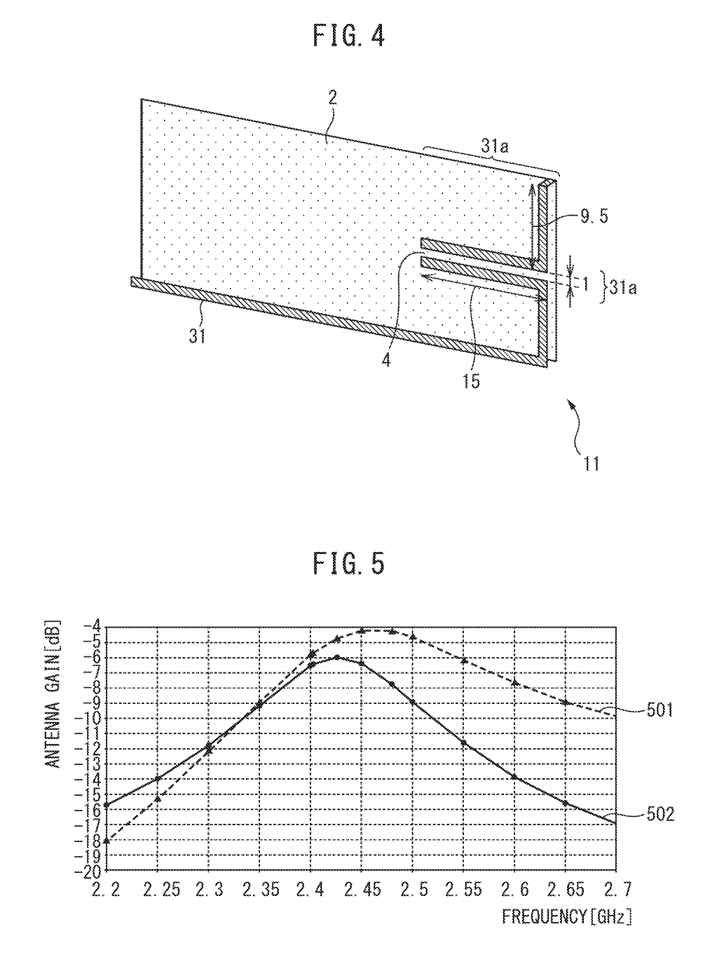

FIG. 4 is a perspective view of the linear antenna according to the second embodiment. The linear antenna 11 according to the second embodiment includes a grounded conductor 2 and a radiation conductor 31. The linear antenna 11 according to the second embodiment is different from the linear antenna 1 according to the first embodiment in that the shape of the radiation conductor 31 is different from the shape of the radiation conductor 3. In view of this, the following explains the differences relating to the radiation conductor 31.

The linear antenna 11 according to the second embodiment includes, in the radiation conductor 31, a portion 31a with parallel tracks (hereinafter referred to as “parallel track portion”), which is formed of folding the radiation conductor 31, into a U shape, in the direction from the outer edge to the center of the grounded conductor 2. The feed point 4 is provided on a tip of the parallel track portion 31a, i.e., an end point of the parallel track portion 31a, which is nearer to the center than to the outer edge of the grounded conductor 2. By doing so, when the linear antenna 11 is placed in proximity to another conductor, the effect of the other conductor on the radiation conductor 31 will be even further alleviated. As a result, the linear antenna 11 can even further suppress the variation in antenna gain between when the linear antenna 11 is placed in the air and when the linear antenna 11 is placed on an object made of metal.

FIG. 5 is a diagram illustrating frequency characteristics of an antenna gain in the front direction, when the linear antenna 11 according to the second embodiment is placed in the air and when the linear antenna 11 is placed on an object made of metal, which are obtained in electromagnetic field simulation. In FIG. 5, the horizontal axis represents a frequency, and the vertical axis represents an antenna gain in the front direction. Note that in this electromagnetic field simulation, just as illustrated in FIG. 4, the length of the parallel track portion 31a is 15 mm, and the interval for the radiation conductor 31 at the parallel track portion 31a is 1 mm. The other size of each part is the same as the size illustrated in FIG. 2. In this electromagnetic field simulation, no matching circuit is used.

The graph 501 represents frequency characteristics of the antenna gain when the linear antenna 11 is placed in the air. The graph 502 represents frequency characteristics of the antenna gain when the linear antenna 11 is placed on an object made of metal. As illustrated in the graph 501 and the graph 502, even when no matching circuit is used, the minimum difference in the antenna gains when the linear antenna 11 is placed in the air and when the linear antenna 11 is placed on an object made of metal is reduced down to about 1.5 dB. From this, it is understood that the linear antenna 11 is able to sufficiently suppress the variation in antenna gain due to the difference in the installation environment.

Although there is no particular limitation on the length of the parallel track portion 31a, the length of the parallel track portion 31a is preferably determined so that the feed point 4 is about several millimeters or more away from any of the outer edges of the grounded conductor 2, so as to alleviate the effect of another conductor. In addition, even when the parallel track portion 31a is provided, the radiation conductor 31 is preferably formed so that the length of the entire radiation conductor 31 is substantially (¼+N/2)λ.

In a modification example of the linear antenna 11 according to the second embodiment, the interval of the parallel track portion 31a of the radiation conductor 31 may be wider than that in the second embodiment.

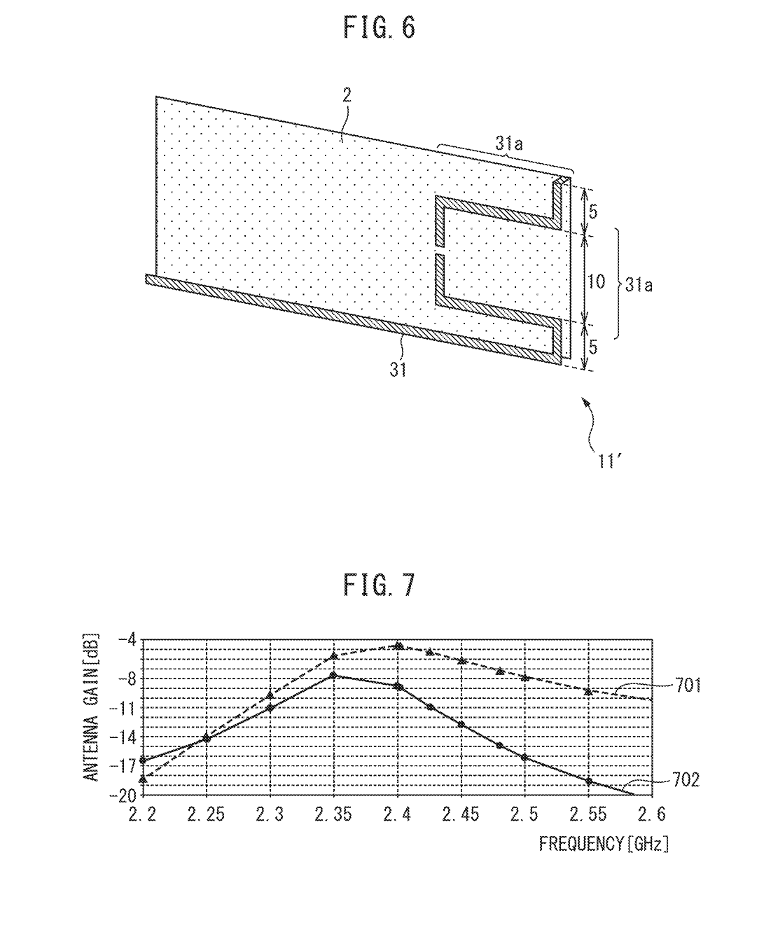

FIG. 6 is a perspective view of a linear antenna according to this modification example. The linear antenna 11′ according to this modification example is different from the linear antenna 11 according to the second embodiment, in that the interval for the radiation conductor 31 at the parallel track portion 31a is wider than that in the linear antenna 11 according to the second embodiment.

FIG. 7 is a diagram illustrating frequency characteristics of an antenna gain in the front direction, when the linear antenna 11′ according to this modification example is placed in the air and when the linear antenna 11′ is placed on an object made of metal, which are obtained in electromagnetic field simulation. In FIG. 7, the horizontal axis represents a frequency, and the vertical axis represents an antenna gain in the front direction. Note that in this electromagnetic field simulation, the length of the parallel track portion 31a is 15 mm, and the interval of the parallel track portion 31a of the radiation conductor 31 is 10 mm. The other size of each part is the same as the size illustrated in FIG. 2 and FIG. 4. Also in this electromagnetic field simulation, no matching circuit is used.

The graph 701 represents frequency characteristics of the antenna gain when the linear antenna 11′ is placed in the air. The graph 702 represents frequency characteristics of the antenna gain when the linear antenna 11′ is placed on an object made of metal. As illustrated in the graph 701 and the graph 702, the minimum difference between the antenna gains respectively resulting when the linear antenna 11′ is placed in the air and when the linear antenna 11′ is placed on an object made of metal is about 2 dB, which is slightly greater than the minimum difference of the antenna gain for the linear antenna 11. Nonetheless, the linear antenna 11′ can sufficiently suppress the variation in antenna gain due to the difference in the installation environment.

According to still another modification example, the width of a portion of the fixed end of the radiation conductor to be connected to the grounded conductor may be wider than the line width of the other portion of the radiation conductor.

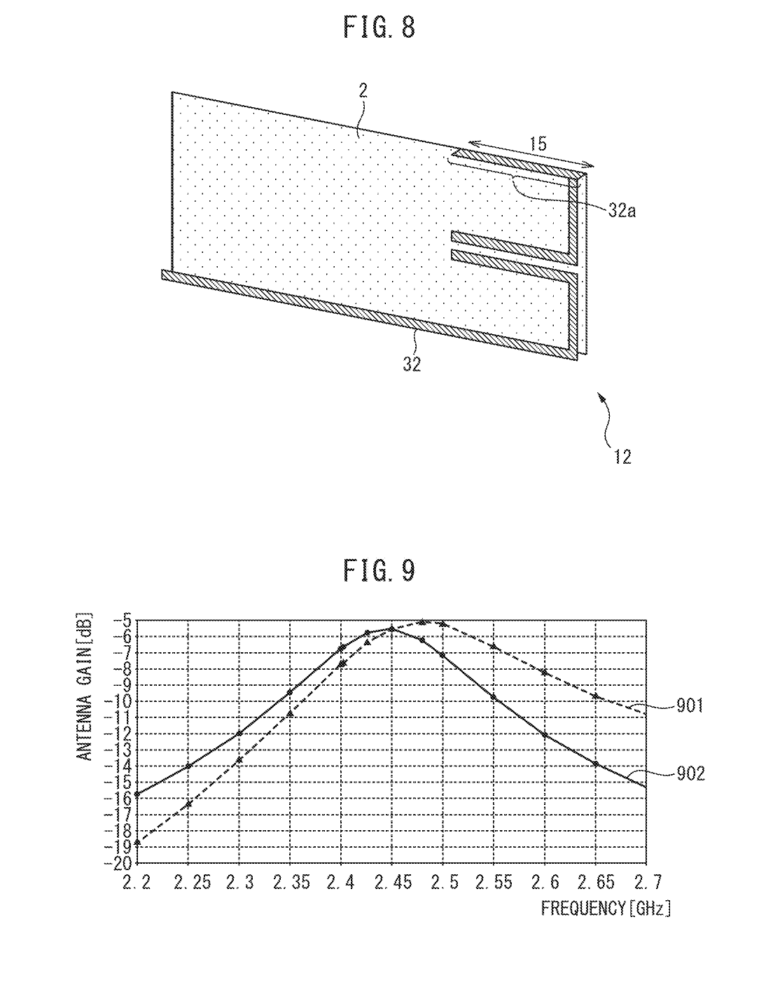

FIG. 8 is a perspective view of a linear antenna according to this modification example. The linear antenna 12 according to this modification example is different from the linear antenna 11 according to the second embodiment, in that the width of the connecting portion 32a of the radiation conductor 32 at the fixed end, which is connected to the grounded conductor 2, is wider than the line width of any other portion of the radiation conductor 32. As illustrated in FIG. 8, the connecting portion 32a is provided from the fixed end to the folding point, along the normal direction of the grounded conductor 2. The connecting portion 32a has a width along the direction (i.e. the long side direction of the grounded conductor 2) orthogonal to the direction in which the radiation conductor 32 extends from the fixed end (in this example, this is the short side direction of the grounded conductor 2), which is wider than the line width of the other portion of the radiation conductor 32. Furthermore, the connecting portion 32a is electrically connected to the grounded conductor 2 at one side having the large width. By having such a connecting portion, the antenna gain when the antenna is placed in the air is slightly suppressed, and the influence of another conductor on the radiation conductor 31 is alleviated further. As a result, the linear antenna 12 can reduce the difference between the antenna gains respectively resulting when it is placed in the air and when it is placed on an object made of metal. As the width of the connecting portion gets narrower, the frequency characteristics of the antenna gain of the linear antenna 12 become nearer to the frequency characteristics of the antenna gain for the linear antenna that does not have such a connecting portion.

FIG. 9 is a diagram illustrating frequency characteristics of an antenna gain in the front direction, when the linear antenna 12 according to the modification example is placed in the air and when the linear antenna 12 is placed on an object made of metal, which are obtained in electromagnetic field simulation. In FIG. 9, the horizontal axis represents a frequency, and the vertical axis represents an antenna gain in the front direction. Note that in this electromagnetic field simulation, the width of the connecting portion 32a in the long side direction of the grounded conductor 2 is 15 mm. The other size of each part is the same as the size illustrated in FIG. 2 and FIG. 4. In this electromagnetic field simulation, no matching circuit is used.

The graph 901 represents frequency characteristics of the antenna gain when the linear antenna 12 is placed in the air. The graph 902 represents frequency characteristics of the antenna gain when the linear antenna 12 is placed on an object made of metal. The difference between the antenna gains respectively resulting when the linear antenna is placed in the air and when the linear antenna is placed on an object made of metal over a frequency band between 2.4 GHz to 2.48 GHz which is used in BLE is about 2 dB or smaller, which suggests that the variation in antenna gain due to the difference in the installation environment is sufficiently suppressed.

According to still another modification example, the grounded conductor may be provided with a cut-off portion at a position not overlapping with at least a part of the radiation conductor.

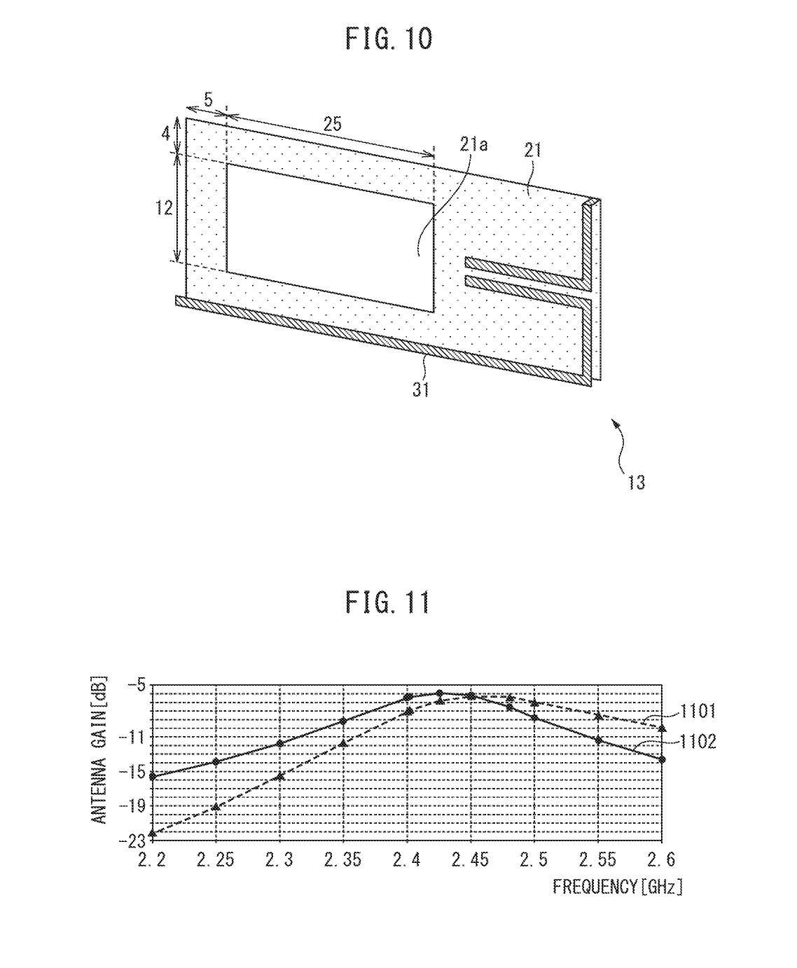

FIG. 10 is a perspective view of a linear antenna according to this modification example. A linear antenna 13 according to this modification example is different from the linear antenna 11 according to the second embodiment, in that a cut-off hole 21a is provided through the grounded conductor 21 at a position not overlapping the radiation conductor 31. The cut-off hole 21a is an example of the cut-off portion provided for the grounded conductor.

By including such a cut-off hole 21a, the area of the grounded conductor 21 is reduced. Therefore, the antenna gain is slightly suppressed when the linear antenna 13 is placed in the air. As a result, the linear antenna 13 can further reduce the difference between antenna gains respectively resulting when the linear antenna 13 is placed in the air and when the linear antenna 13 is placed on an object made of metal.

FIG. 11 is a diagram illustrating frequency characteristics of an antenna gain in the front direction, when the linear antenna 13 according to this modification example is placed in the air and when the linear antenna 13 is placed on an object made of metal, which are obtained in electromagnetic field simulation. In FIG. 11, the horizontal axis represents a frequency, and the vertical axis represents an antenna gain in the front direction. Note that in this electromagnetic field simulation, the length of the cut-off hole 21a along the lengthwise direction of the grounded conductor 21 is 25 mm, and the length thereof along the widthwise direction of the grounded conductor 21 is 12 mm. The distance from the short side of the grounded conductor 21 opposite to the end where the fixed end of the radiation conductor 31 is provided to the cut-off hole 21a is 5 mm, and the distance from each of the two long sides of the grounded conductor 21 to the cut-off hole 21a is 4 mm. The other size of each part is the size as those illustrated in FIG. 2 and FIG. 4. In this electromagnetic field simulation, no matching circuit is used.

The graph 1101 represents frequency characteristics of the antenna gain when the linear antenna 13 is placed in the air. The graph 1102 represents frequency characteristics of the antenna gain when the linear antenna 13 is placed on an object made of metal. The difference in the antenna gains respectively resulting when the linear antenna 13 is placed in the air and when the linear antenna 13 is placed on an object made of metal over a frequency band between 2.4 GHz to 2.48 GHz which is used in BLE is about 2 dB or smaller, which suggests that the variation in antenna gain due to the difference in the installation environment is sufficiently suppressed.

The shape of the cut-off portion of the grounded conductor is not limited to that illustrated in FIG. 10.

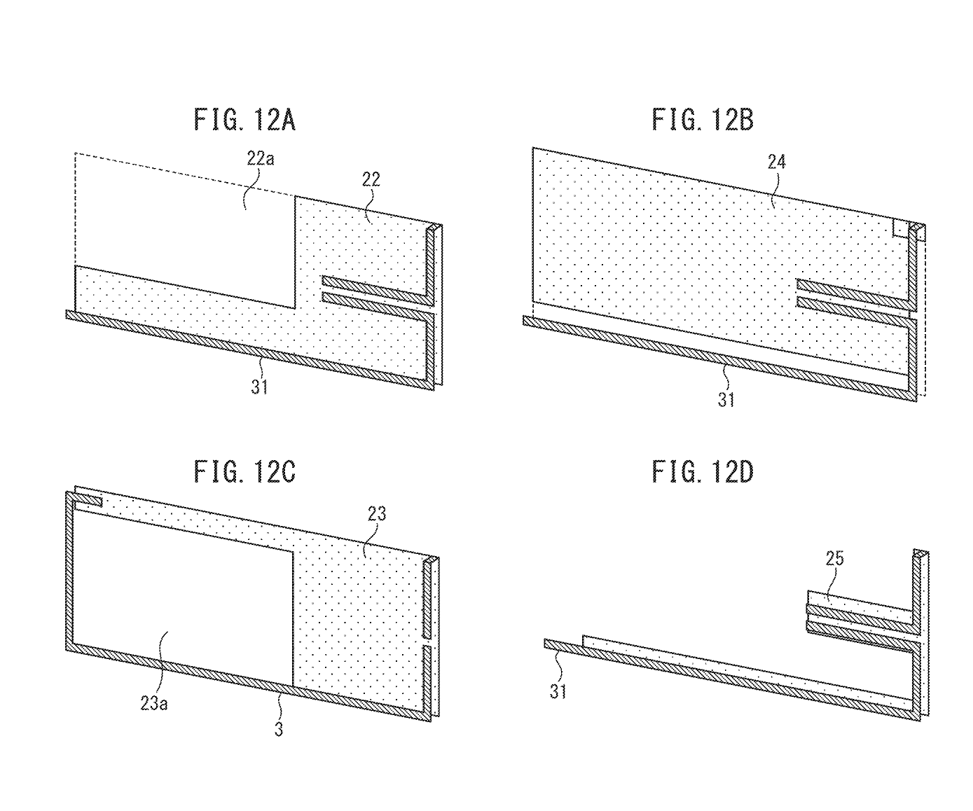

Each of FIG. 12A to FIG. 12D is a perspective view of a modification example of the linear antenna in which the grounded conductor includes a cut-off portion. In the example illustrated in FIG. 12A, the grounded conductor 22 is formed as a L shape to overlap with the radiation conductor 31, and includes a cut-off portion 22a in a rectangular shape in a position not overlapping with the radiation conductor 31.

In the example illustrated in FIG. 12B, a cut-off portion 23a in a rectangular shape is provided in a position diagonal to the fixed end so that a part of the radiation conductor 3 of the linear antenna 1 according to the first embodiment does not overlap with the grounded conductor 23. In other words, the radiation conductor 3 overlaps with the grounded conductor 23, only in the vicinity of the open end and in the portion from the fixed end to the midway through the radiation conductor 3.

In the example illustrated in FIG. 12C, the grounded conductor 24 is formed so that a part of the radiation conductor 31 of the linear antenna 11 according to the second embodiment does not overlap with the grounded conductor 24. In this example, so that the portion other than the parallel track portion 31a of the radiation conductor 31 does not overlap with the grounded conductor 24, the outer edge portion (the right edge and the lower edge in FIG. 12C) of the grounded conductor 24 along the radiation conductor 31 is omitted by about several millimeters.

In the example illustrated in FIG. 12D, the grounded conductor 25 is formed to have an outer shape that corresponds to the radiation conductor 31, and the portion other than the portion overlapping with the radiation conductor 31 is substantially omitted. However, even in this example, the area of the grounded conductor 25 is wider than the area of the radiation conductor 31.

Even in these modification examples, since the area of the grounded conductor is decreased, the antenna gain is slightly reduced when the linear antenna is placed in the air. As a result, the linear antenna according to these modification examples can further reduce the difference in the antenna gains respectively resulting when the linear antenna is placed in the air and when the linear antenna is placed on an object made of metal. Even when the grounded conductor and the radiation conductor are formed so that a part of the radiation conductor does not overlap with the grounded conductor, the feed point of the radiation conductor preferably overlaps with the grounded conductor. By doing so, the effect of another conductor on the radiation conductor will be alleviated.

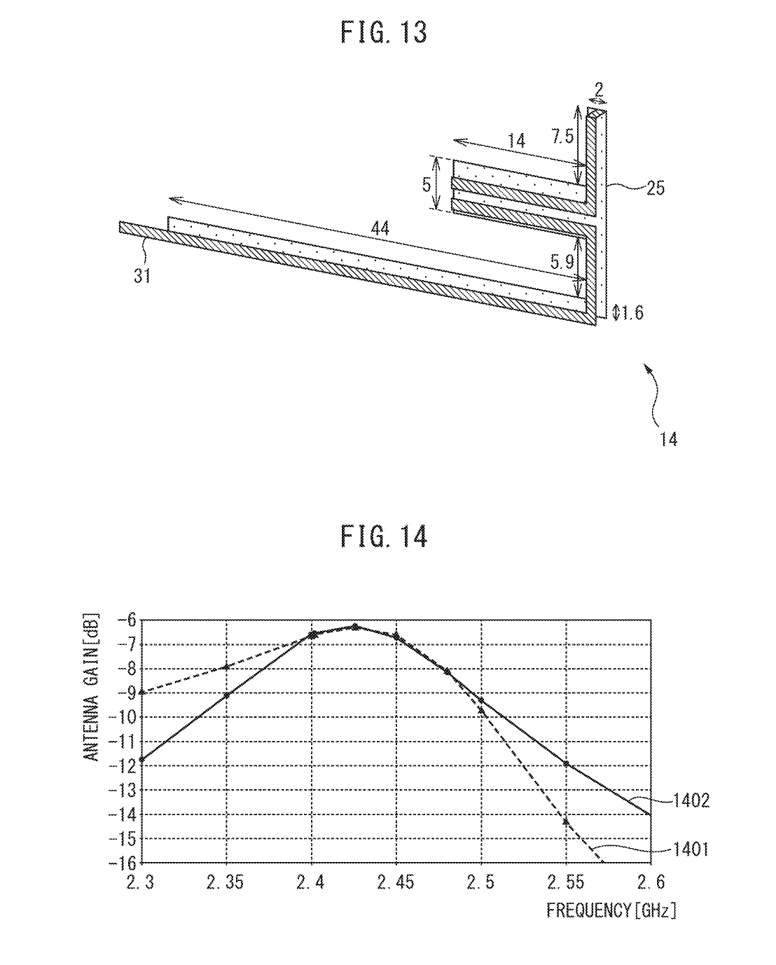

FIG. 13 illustrates a size of each part of the grounded conductor 25, when the antenna gain for the linear antenna 14 according to the modification example illustrated in FIG. 12D which is placed in the air substantially matches with the antenna gain for the linear antenna which is placed on an object made of metal, at a certain frequency band. In this example, the width of the grounded conductor 25 from the fixed end of the radiation conductor 31 to the folding point between the parallel track portion 31a and the open end is 2 mm. The width at the parallel track portion 31a in the direction orthogonal to the lengthwise direction of the parallel tracks is 5 mm, and the length in the direction parallel to the lengthwise direction of the parallel tracks is 14 mm. The length of a section from the folding point between the parallel track portion 31a and the open end along the open end is 44 mm, and the width of the section is 1.6 mm. The size of the radiation conductor 31 is set to be the same as that illustrated in FIG. 2 and FIG. 4. In this electromagnetic field simulation, no matching circuit is used.

FIG. 14 is a diagram illustrating frequency characteristics of an antenna gain in the front direction, when the linear antenna 14 according to the modification examples illustrated in FIG. 12D and FIG. 13 is placed in the air and when the linear antenna 14 is placed on an object made of metal, which are obtained in electromagnetic field simulation. In FIG. 14, the horizontal axis represents a frequency, and the vertical axis represents an antenna gain in the front direction.

The graph 1401 represents frequency characteristics of the antenna gain when the linear antenna 14 is placed in the air. The graph 1402 represents frequency characteristics of the antenna gain when the linear antenna 14 is placed on an object made of metal. As illustrated in the graph 1401 and the graph 1402, the antenna gains are substantially equal to each other between when the linear antenna is placed in the air and when the linear antenna is placed on an object made of metal over a frequency band between 2.4 GHz to 2.48 GHz which is used in BLE.

According to still another modification example, the radiation conductor may be formed so that the portion of the radiation conductor other than the parallel track portion may be positioned inner than the outer edge of the grounded conductor.

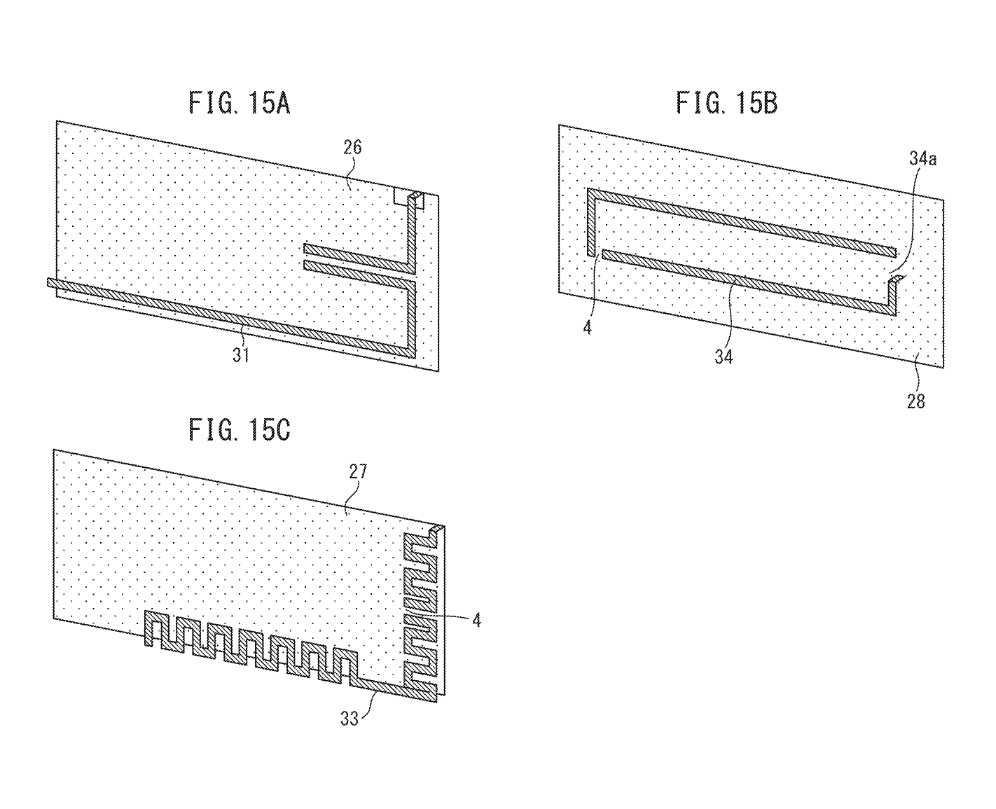

Each of FIG. 15A to FIG. 15C is a perspective view of a modification example of the linear antenna in which the radiation conductor is formed such that the portion other than the parallel track portion of the radiation conductor is positioned inner than the outer edge of the grounded conductor.

In the example illustrated in FIG. 15A, the grounded conductor 26 is extended so that the portion of the radiation conductor 31 other than the parallel track portion 31a is positioned inner than the outer edge of the grounded conductor 26. In this example, the outer edge portion (the right edge and the lower edge in FIG. 15A) of the grounded conductor 26 along the radiation conductor 31 is extended by about several millimeters.

In the example illustrated in FIG. 15B, the entire radiation conductor 33 is formed to meander. Therefore, a part of the radiation conductor 33 is positioned inner than the outer edge of the grounded conductor 27. Note that in this example, just as in the case in which the parallel track portion is formed, the feed point 4 is preferably formed inner than the outer edge of the grounded conductor 27. However, the feed point 4 may be provided at a position along the outer edge of the grounded conductor 27.

In the example illustrated in FIG. 15C, the fixed end 34a itself of the radiation conductor 34 is positioned inner than the outer edge of the grounded conductor 28. The entire radiation conductor 34 is also positioned inner than the outer edge of the grounded conductor 28. Also in this modification example, the feed point 4 is preferably set such that the distance from the open end to the feed point 4 is not nλ/2, wherein n is an integer not lower than 1. By doing so, the phenomenon in which the open end works as a node of a standing wave for the radio wave having the designed wavelength to make it harder for the radiation conductor 34 to radiate the radio wave, can be suppressed. It should be noted that, if the entire radiation conductor 34 is positioned inner than the outer edge portion of the grounded conductor 28, just as in the example illustrated in FIG. 15C, the feed point 4 may be provided at the fixed end of the radiation conductor 34.

Also in the linear antennas according to the modification examples as illustrated in FIG. 10, FIG. 12A to FIG. 12D, and FIG. 15A to FIG. 15D, the radiation conductor may include a connecting portion as illustrated in FIG. 8.

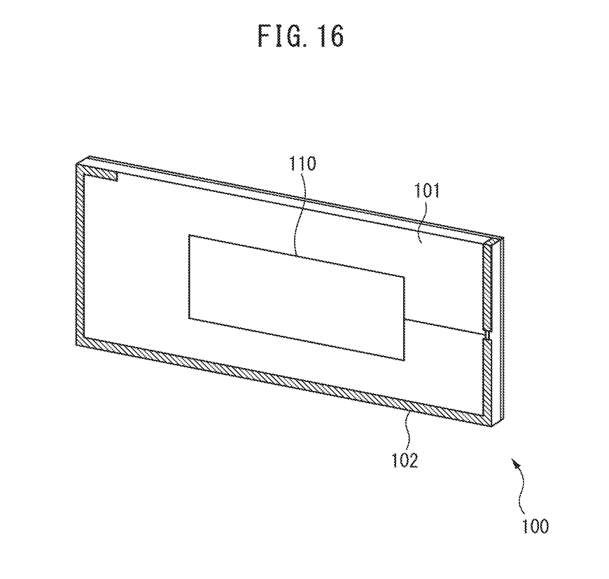

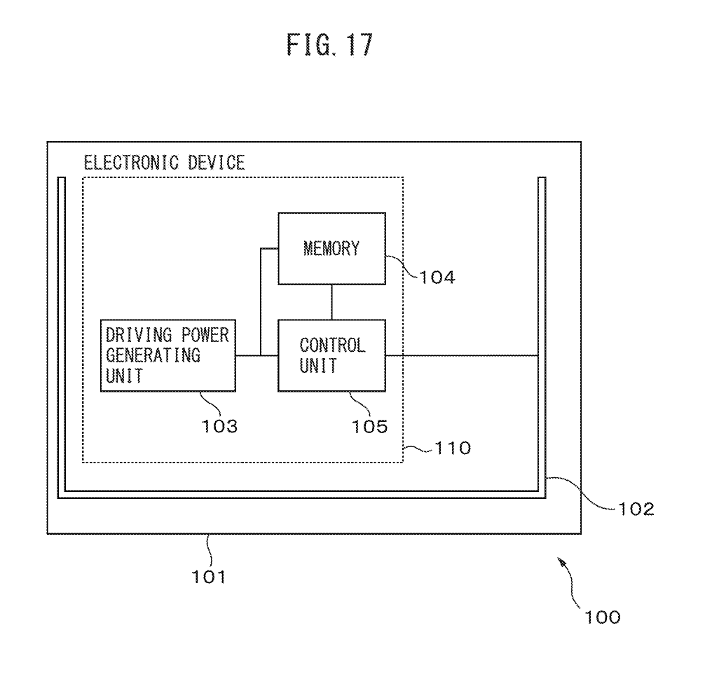

FIG. 16 is a schematic perspective view of an electronic device which includes the linear antenna according to any of the embodiments or their modification examples described above. FIG. 17 is a block diagram of circuitry included in the electronic device. In this example, the electronic device 100 is a beacon apparatus, and includes a substrate 101, a linear antenna 102, a driving power generating unit 103, a memory 104, and a control unit 105. Among them, the driving power generating unit 103, the memory 104, and the control unit 105 are an example of the signal processing circuit 110 that radiates a radio signal via the linear antenna 102. In addition, the memory 104 and the control unit 105 may be formed as one or more integrated circuits, for example. The electronic device 100 may further include, between the signal processing circuit 110 and the linear antenna 102, a matching circuit (not illustrated in the drawings) to match the impedance of the signal processing circuit 110 and the impedance of the linear antenna 102.

The substrate 101 is formed, for example, by a dielectric such as a synthetic resin, for example, an ABS resin, a PET resin, and a polycarbonate resin, to have a rectangular plate shape. The grounded conductor of the linear antenna 102 is mounted on one surface of the substrate 101, and the signal processing circuit 110 and the radiation conductor of the linear antenna 102 are mounted on the other surface of the substrate 101, for example. In the following, for convenience, a surface of the substrate 101 on which the grounded conductor of the linear antenna 102 is mounted is referred to as “back surface”, and a surface which is opposite to the back surface, and on which the signal processing circuit 110 or the like is mounted is referred to as “front surface”. The signal processing circuit 110 is mounted in an area of the front surface of the substrate 101 on which the radiation conductor of the linear antenna 102 is not mounted.

The linear antenna 102 is a linear antenna according to any of the embodiments or their modification examples described above. The linear antenna 102 radiates the radio signal received from the control unit 105 as a radio wave, for example.

The driving power generating unit 103 generates a power to drive the memory 104 and the control unit 105. So as to do this, the driving power generating unit 103 includes a solar cell, for example. Furthermore, the driving power generating unit 103 may include a power storage element such as a capacitor for storing power generated by the solar cell. The driving power generating unit 103 supplies the generated power to the memory 104 and the control unit 105.

The memory 104 includes a non-volatile semiconductor memory circuit. The memory 104 stores an ID code to identify the electronic device 100 from other electronic devices.

The control unit 105 is connected to the feed point of the linear antenna 102 either directly or through a matching circuit. The control unit 105 includes at least one processor, and generates a radio signal in accordance with a predetermined radio communication specification such as BLE. The control unit 105 may read an ID code of the electronic device 100 from the memory 104, and incorporate the ID code in the radio signal. The control unit 105 outputs the radio signal to the linear antenna 102, and causes the linear antenna 102 to radiate the radio signal as a radio wave.

Note that the electronic device 100 may be a sensor terminal used for an Internet of Things (IoT). In this case, the electronic device 100 may include one or more sensors for sensing information concerning an object to which the electronic device 100 is attached, other than the constituting elements described above. The control unit 105 may incorporate, in a radio signal, the information obtained from the sensor.

Alternatively, the electronic device 100 may be a radio tag. In this case, the driving power generating unit 103 may generate a power to drive the memory 104 and the control unit 105, from the radio signal received from the reader/writer (not illustrated in the drawings) via the linear antenna 102. The control unit 105 demodulates a radio signal received from the linear antenna 102, to take out an inquiry signal conveyed by the radio signal. The control unit 105 may generate a response signal corresponding to the inquiry signal. The control unit 105 reads an ID code from the memory 104, and incorporates the ID code in the response signal. The control unit 105 superposes the response signal on a radio signal having a frequency to radiate from the linear antenna 102. Then, the control unit 105 outputs the radio signal to the linear antenna 102, and causes the linear antenna 102 to radiate the radio signal as a radio wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A linear antenna comprising:
a first conductor which is formed as a plate, is conductive and is grounded; and
a second conductor which is conductive, is connected at one end of the second conductor to the first conductor, includes an electrical length obtained by adding ¼ of a designed wavelength to an integer multiple of a half of the designed wavelength and includes a first section from a folding point between the one end and an another end of which the second conductor is an open end to the another end along a surface parallel to a surface on which the first conductor is formed, wherein the second conductor is fed at a feed point in the first section, and at least a part of the first section including the feed point is formed to overlap with the first conductor when the first section is projected along a normal direction of the surface on which the first conductor is formed.

2. The linear antenna according to claim 1, wherein
at least the part of the first section of the second conductor including the feed point is positioned inner than an outer edge of the first conductor.

3. The linear antenna according to claim 2, wherein
at least the part of the first section including the feed point is formed as a parallel track.

4. The linear antenna according to claim 1, further comprising:
a matching circuit which is connected to the feed point and is configured to match an impedance of the linear antenna with a certain impedance when the linear antenna is placed on another conductor such that the first conductor is positioned between the second conductor and the another conductor.

5. The linear antenna according to claim 1, wherein
a width of the second conductor along a direction in which the second conductor is connected to the first conductor at the one end is larger than a width of the second conductor in the first section.

6. The linear antenna according to claim 3, wherein
the first conductor is formed so that an outer shape of the first conductor is along with the second conductor.

7. An electronic device comprising:
a substrate;
a linear antenna; and
a signal processing circuit which is mounted on one surface of the substrate, and is configured to radiate or receive a radio wave via the linear antenna, wherein
the linear antenna includes:
a first conductor which is mounted on a surface opposite to the one surface of the substrate, is conductive and is grounded; and
a second conductor which is conductive, is connected at one end of the second conductor to the first conductor, includes an electrical length obtained by adding ¼ of a designed wavelength to an integer multiple of a half of the designed wavelength, and includes a first section from a folding point between the one end and an another end of which the second conductor is an open end to the another end along the one surface of the substrate, wherein the second conductor is connected to the signal processing circuit at a feed point in the first section, and at least a part of the first section including the feed point is formed to overlap with the first conductor when the first section is projected along a normal direction of the surface on which the first conductor is formed.
